(19) United States
(12) Patent Application Publication
(10) Pub. No.: US 2022/0006187 A1
(43) Pub. Date: Jan. 6, 2022

(54) ANTENNA ELEMENT ARRANGEMENT

(71) Applicant: Sequans Communications S.A., Colombes (FR)

(72) Inventors: James Watts, Colombes (FR); Thomas Winiecki, Colombes (FR)

(21) Appl. No.: 16/920,522

(22) Filed: Jul. 3, 2020

(51) Int. Cl. H01Q 3/36; H01Q 3/26; H01Q 21/06

(52) U.S. Cl. CPC H01Q 3/36; H01Q 21/061; H01Q 3/2617

(57) ABSTRACT

The present disclosure relates to an antenna element arrangement configured for use with a plurality of phase shifters, the antenna element arrangement comprising: a first group of elements comprising a first plurality of elements aligned in a first direction, each element in the first plurality of elements arranged to accept, in a transmit mode, a first electrical signal from a first phase shifter or to supply, in a receive mode, a first electrical signal to the first phase shifter; and a second group of elements comprising a second plurality of elements aligned in a second direction, each element in the second plurality of elements arranged to accept, in the transmit mode, a second electrical signal from a second phase shifter or to supply, in the receive mode, a second electrical signal to the second phase shifter; wherein the first and second directions are nonparallel.

### FIELD

The present disclosure relates to an antenna element arrangement. In particular, the present disclosure relates to an antenna element arrangement configured for use with a plurality of phase shifters.

### BACKGROUND

Phased array antennas have been used for many applications, including steerable radar applications, signal broadcasting, satellite communications. One recent application of phased array antennas is for cellular communication equipment at millimetre wave frequencies, as introduced with the New Radio standard of 3GPP (also known as 5G).

The key performance parameters for a phased array are directivity (or antenna gain) and angular scan range. Both parameters generally improve with larger arrays. However, larger arrays are more expensive and consume more power.

Accordingly, there exists a need for maximising directivity and useful scan range of a phased array antenna, without increasing cost or power consumption.

### SUMMARY

This summary introduces concepts that are described in more detail in the detailed description. It should not be used to identify essential features of the claimed subject matter, nor to limit the scope of the claimed subject matter.

According to one aspect of the present disclosure, there is provided an antenna element arrangement as defined in claim 1. According to another aspect of the present disclosure, there is provided a method of transmitting an electromagnetic signal as defined in claim 18. According to a further aspect, there is provided a method of receiving an electromagnetic signal as defined in claim 19.

Set out below are a series of numbered clauses that disclose features of further aspects, which may be claimed. The clauses that refer to one or more preceding clauses contain optional features.

1. An antenna element arrangement configured for use with a plurality of phase shifters, the antenna element arrangement comprising:
a first group of elements comprising a first plurality of elements aligned in a first direction, each element in the first plurality of elements arranged to accept, in a transmit mode, a first electrical signal from a first phase shifter or to supply, in a receive mode, a first electrical signal to the first phase shifter; and
a second group of elements comprising a second plurality of elements aligned in a second direction, each element in the second plurality of elements arranged to accept, in the transmit mode, a second electrical signal from a second phase shifter or to supply, in the receive mode, a second electrical signal to the second phase shifter;
wherein the first and second directions are nonparallel.

2. An antenna element arrangement according to clause 1, wherein the first direction is perpendicular to the second direction.

3. An antenna element arrangement according to clause 1 or clause 2, wherein in the transmit mode, each element in the first plurality of elements is arranged to transmit an electromagnetic signal with a first phase delay and each element in the second plurality of elements is arranged to transmit the electromagnetic signal with a second phase delay, wherein the second phase delay is different to the first phase delay.

4. An antenna element arrangement according to any of clauses 1 to 3, wherein in the receive mode, each element in the first plurality of elements is arranged to receive an electromagnetic signal with a first phase delay and each element in the second plurality of elements is arranged to receive the electromagnetic signal with a second phase delay, wherein the second phase delay is different to the first phase delay.

5. An antenna element arrangement according to any of clauses 1 to 4, wherein the first electrical signal has a first phase delay and the second electrical signal has a second phase delay different to the first phase delay.

6. An antenna element arrangement according to any of clauses 1 to 5, wherein each of the first and second groups of elements is a pair of elements.

7. An antenna element arrangement according to any of clauses 1 to 6, comprising a first plurality of groups of elements aligned in the first direction.

8. An antenna element arrangement according to clause 7, comprising a second plurality of groups of elements aligned in the second direction.

9. An antenna element arrangement according to clause 8, wherein the number of groups of elements in the first plurality of groups of elements is equal to the number of groups of elements in the second plurality of groups of elements.

10. An antenna element arrangement according to any of clauses 7 to 9, wherein the first plurality of groups of elements comprises the first group of elements and a third group of elements, wherein each element in the first group of elements is adjacent to an element of the third group of elements.

11. An antenna element arrangement according to clause 10, wherein the second plurality of groups of elements comprises the second group of elements and a fourth group of elements, wherein each element in the second group of elements is adjacent to an element of the fourth group of elements.

12. An antenna element arrangement according to any of clauses 1 to 11, wherein the elements are arranged in an array.

13. An antenna element arrangement according to clause 12, wherein the array is a two-dimensional array.

14. An antenna element arrangement according to any of clauses 1 to 13, wherein the first direction is parallel to an elevation direction of an antenna.

15. An antenna element arrangement according to any of clauses 1 to 14, wherein the second direction is parallel to an azimuth direction of an antenna.

16. An antenna element arrangement according to any of clauses 1 to 15, further comprising a plurality of individual elements, wherein each individual element is arranged to transmit, in the transmit mode, an electromagnetic signal with a different phase delay to the electromagnetic signals transmitted by the groups of elements.

17. An antenna element arrangement according to any of clauses 1 to 16, wherein the groups of elements are arranged such that the alignment of a first element of the first group of elements and a second element of the first group of elements is angled with respect to the alignment of a first element of the second group of elements and a second element of the second group of elements.

18. An antenna element arrangement according to any of clauses 1 to 17, wherein the groups of elements are arranged such that a first centerline through a first element of the first group of elements and a second element of the first group of elements is at an angle to a second centerline through a first element of the second group of elements and a second element of the second group of elements.

19. An antenna element arrangement configured for use with a plurality of phase shifters, the antenna element arrangement comprising:
a first group of elements comprising a first plurality of elements aligned in a first direction, each element in the first plurality of elements arranged to accept a first electrical signal from a first phase shifter; and
a second group of elements comprising a second plurality of elements aligned in a second direction, each element in the second plurality of elements arranged to accept a second electrical signal from a second phase shifter;
wherein the first and second directions are nonparallel.

20. An antenna element arrangement configured for use with a plurality of phase shifters, the antenna element arrangement comprising:
a first group of elements comprising a first plurality of elements aligned in a first direction, each element in the first plurality of elements arranged to supply a first electrical signal to the first phase shifter; and
a second group of elements comprising a second plurality of elements aligned in a second direction, each element in the second plurality of elements arranged to supply a second electrical signal to the second phase shifter;
wherein the first and second directions are nonparallel.

21. An antenna comprising an antenna element arrangement according to any of clauses 1 to 20.

22. A method of transmitting an electromagnetic signal using an antenna comprising an antenna element arrangement, the method comprising:
accepting, at each element in a first plurality of elements of the antenna element arrangement, a first electrical signal from a first phase shifter, wherein the first plurality of elements is aligned in a first direction;
accepting, at each element in a second plurality of elements of the antenna element arrangement, a second electrical signal from a second phase shifter, wherein the second plurality of elements is aligned in a second direction, wherein the first and second directions are nonparallel;
transmitting an electromagnetic signal with a first phase delay from each element of the first plurality of elements; and
transmitting the electromagnetic signal with a second phase delay from each element of the second plurality of elements.

23. A method of receiving an electromagnetic signal using an antenna comprising an antenna element arrangement, comprising:
receiving an electromagnetic signal with a first phase delay at each element in a first plurality of elements of the antenna element arrangement, wherein the first plurality of elements is aligned in a first direction; and
receiving the electromagnetic signal with a second phase delay at each element in a second plurality of elements of the antenna element arrangement, wherein the second plurality of elements is aligned in a second direction, wherein the first and second directions are nonparallel;
supplying, by each element in the first plurality of elements, a first electrical signal to a first phase shifter; and
supplying, by each element in the second plurality of elements, a second electrical signal to a second phase shifter.

24. A method of transmitting an electromagnetic signal using an antenna comprising an antenna element arrangement, the method comprising:
accepting, at each element in a first plurality of elements of the antenna element arrangement, a first electrical signal from a first phase shifter, wherein the first plurality of elements is aligned in a first direction; and
accepting, at each element in a second plurality of elements of the antenna element arrangement, a second electrical signal from a second phase shifter, wherein the second plurality of elements is aligned in a second direction, wherein the first and second directions are nonparallel.

25. A method according to clause 24, further comprising:
transmitting an electromagnetic signal with a first phase delay from each element of the first plurality of elements; and
transmitting the electromagnetic signal with a second phase delay from each element of the second plurality of elements.

26. A method of receiving an electromagnetic signal using an antenna comprising an antenna element arrangement, comprising:
supplying, by each element in the first plurality of elements of the antenna element arrangement, a first electrical signal to a first phase shifter, wherein the first plurality of elements is aligned in a first direction; and
supplying, by each element in the second plurality of elements, a second electrical signal to a second phase shifter of the antenna element arrangement, wherein the second plurality of elements is aligned in a second direction, wherein the first and second directions are nonparallel.

27. A method according to clause 26, further comprising:
receiving an electromagnetic signal with a first phase delay at each element in the first plurality of elements; and
receiving the electromagnetic signal with a second phase delay at each element in the second plurality of elements.

### BRIEF DESCRIPTION OF FIGURES

Specific embodiments are described below by way of example only and with reference to the accompanying drawings, in which:

FIG. 1 is a schematic diagram of a phased array transmitter.

FIG. 2 is a schematic diagram of an antenna array for a phased array antenna.

FIG. 3 is a plot of simulated directivity coverage for the phased array antenna of FIG. 2.

FIG. 4 is a schematic diagram of a phased array transmitter with subarraying.

FIG. 5 is a schematic diagram of an antenna array of a phased array antenna with subarraying.

FIG. 6 is a plot of simulated directivity coverage for the phased array antenna of FIG. 5.

FIG. 7 is a schematic diagram of a first antenna element arrangement with groups of co-phased antenna elements oriented in different directions.

FIG. 8 is a plot of simulated directivity coverage for the antenna element arrangement of FIG. 7.

FIG. 9 is a schematic diagram of a second antenna element arrangement with groups of co-phased antenna elements oriented in different directions.

FIG. 10 is a plot of simulated directivity coverage for the antenna element arrangement of FIG. 9.

FIG. 11 is a schematic diagram of a third antenna element arrangement with groups of co-phased antenna elements oriented in different directions.

FIG. 12 is a plot of simulated directivity coverage for the antenna element arrangement of FIG. 11.

FIG. 13 is a schematic diagram of a fourth antenna element arrangement with groups of co-phased antenna elements oriented in different directions.

FIG. 14 is a flowchart of a method of transmitting a signal using an antenna element arrangement with groups of co-phased antenna elements oriented in different directions.

FIG. 15 is a flowchart of a method of receiving a signal using an antenna element arrangement with groups of co-phased antenna elements oriented in different directions.

### DETAILED DESCRIPTION

A phased array antenna is an arrangement of a number of radiating elements that form (or “steer”) a beam of radio waves into a desired direction. Each radiating element is an independent antenna (i.e. an interface from a conductor to electromagnetic waves propagating in free space) in its own right. The radiating elements are usually small and typically less than one half wavelength in any dimension of the signal intended for transmission or reception. Typical radiating elements include “patch”, “dipole” or horn antennas. In transmit mode, each element of the array transmits a phase delayed copy of the same signal.

By appropriately tuning the delay for each element, constructive superposition of all signal phases can be achieved in the desired direction. The transmitted power in this direction is amplified whilst power in other directions is suppressed.

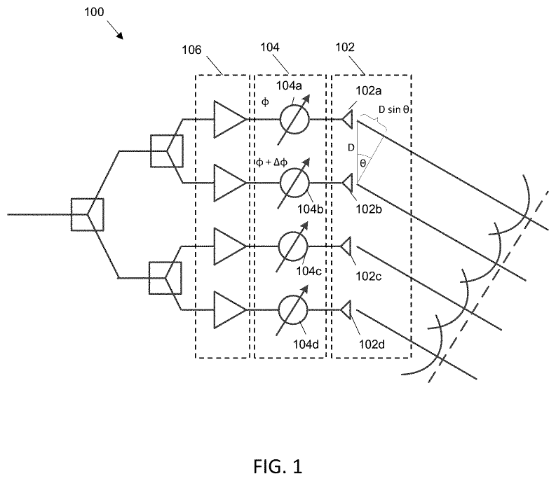

FIG. 1 is a schematic diagram of a phased array transmitter 100. The phased array transmitter 100 includes an array of antenna elements 102. A signal to be transmitted is fed to a number of amplifiers 106 corresponding to the number of antenna elements 102. The output from each amplifier is fed to a corresponding phase shifter 104. Each antenna element 102 is fed with the same signal power level. Each phase shifter 104 delays the signal by a phase delay and feeds the delayed signal to a respective antenna element 102. For example, a first phase shifter 104a feeds an electrical signal with phase φ to a first antenna element 102a, which then transmits a corresponding electromagnetic signal with phase φ. An adjacent antenna element 102b is then fed an electrical signal with phase (φ+Δφ), where Δφ is the phase delay, by a second phase shifter 104b. The antenna element 104b then transmits a corresponding electromagnetic signal with phase (φ+Δφ). The next antenna element 102c is fed an electrical signal with phase (φ+2Δφ) by phase shifter 103c and transmits a corresponding electromagnetic signal with phase (φ+2Δφ). The final antenna element 102d is fed an electrical signal with phase (φ+3Δφ) by phase shifter 103d and transmits a corresponding electromagnetic signal with phase (φ+3Δφ).

The phase delay Δφ between two adjacent antenna elements 102 is a function of the physical distance D between the antenna elements 102, the desired steering angle θ of the transmitted signal, and the wavelength λ of the electromagnetic signal. The phase delay Δφ can be calculated as Δφ=2π D sin θ/λ.

In most applications, the spacing between two adjacent antenna elements 102 is equal and set to λ/2 or a slightly higher value such as 0.7λ. Increased spacing between adjacent elements 102 further focusses the beam and increases angular selectivity, but reduces the beam quality at high steering angles.

The same principle as shown in FIG. 1 for signal transmission applies in the receive direction. In the receive direction, electromagnetic signals are received at the antenna elements. Each antenna element supplies a corresponding electrical signal to a phase shifter, which allows the signals to be delayed by a phase delay before they are summed. By applying the phase delay in this way, the combined signal amplifies the incoming signal power from the desired direction and suppresses the signal power from other directions.

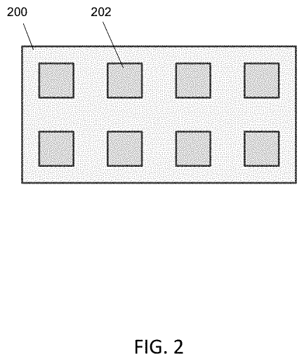

In a two-dimensional antenna array (such as the antenna array 200 shown in FIG. 2, which has eight antenna elements 202), phase delays can be added independently in two directions (such as a horizontal and a vertical direction). This allows the beam to be steered independently in these two independent directions.

More generally, if the elements are not spaced equidistantly on a Cartesian grid, each element location can be described with respect to an arbitrary reference point (e.g. the centre of the array, or a corner element of the array) using a position vector pᵢ. In order to steer a beam in the direction given by the unit direction vector r₀ (corresponding to the desired steering angle θ) the element phase must be set to φᵢ=φ₀+2π pᵢ*r₀/λ where φ₀ is an arbitrary phase offset applied equally to all elements and “⋅” denotes the scalar (or dot or inner) product.

For small to moderate steering angles, the amplitude of the radiated beam is given by the sum of amplitudes from each antenna element 202. Therefore, if the number of antenna elements 202 is changed, then the total radiated power changes proportionally (assuming that each element 202 is still fed at the same power). However, the peak beam power (i.e. the amplitude squared) is approximately proportional to the square of the number of elements 202. This effect is often expressed in terms of array directivity, which measures the power of a signal in the desired direction compared to the expected signal power from an omnidirectional transmitter with uniform signal distribution. The directivity can be expressed in dB(isotropic), or dBi.

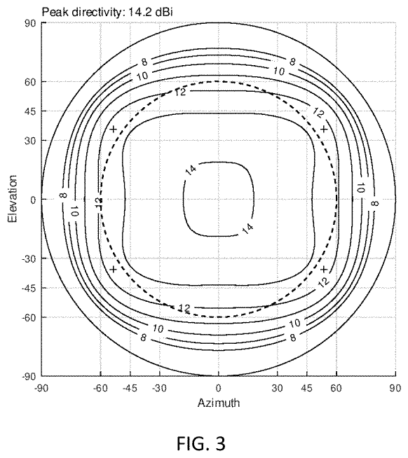

FIG. 3 is a plot of simulated directivity coverage using the antenna array 200 in FIG. 2. Specifically, FIG. 3 shows the simulated achievable directivity in azimuth and elevation directions, assuming that the beam is steered into the direction indicated by the azimuth and elevation parameters. For the plot shown in FIG. 3, an element spacing of λ/2 is assumed.

Even though the antenna array 200 in FIG. 2 is asymmetrical (i.e. a 4×2 array), FIG. 3 shows that the coverage plot is almost symmetrical in azimuth and elevation directions. The peak directivity achieved in the simulation using the antenna array 200 is 14.2 dBi. The dashed line in FIG. 3 shows a circle at a 60° angle from the boresight direction, which covers 50% of the hemisphere above the array. As shown in FIG. 3, approximately 11.5 dBi directivity is achievable anywhere within this circle.

The directivity scales approximately with the square of the number of elements. This means that increasing the number of elements in the antenna array (i.e. the “array size”), the array directivity can be increased.

However, an increased array size requires more components for delay control and signal amplification. Roughly speaking, doubling the array size will double the equipment cost and equipment power consumption. As noted above, however, doubling the array size will quadruple the peak beam power.

One existing technique for boosting array power without adding significant cost is known as subarraying. With subarraying, the phase delayed signal is split again and fed to two elements that are locked together in phase (or “co-phased”).

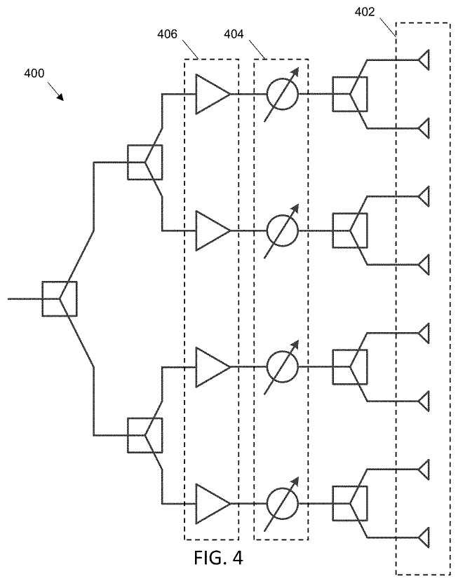

FIG. 4 is a schematic diagram of a phased array transmitter 400 with subarraying. As with the phased array transmitter 100 in FIG. 1, the phased array transmitter 400 in FIG. 4 includes an array of antenna elements 402. A signal to be transmitted is fed to a number of amplifiers 406 corresponding to half of the number of antenna elements 402. The output from each amplifier is fed to a corresponding phase shifter 404. Each antenna element 402 is fed with the same signal power level. Each phase shifter 404 delays the signal by a phase delay. In contrast to the phased array transmitter 100 in FIG. 1, the delayed signal from each phase shifter 404 in FIG. 4 is split and fed to a pair of elements 402 that are locked in phase (referred to herein as “co-phased”).

To steer a beam in a direction, phase weights can be calculated in exactly the same way as for directly fed elements, except that the effective position vector for the paired elements (e.g. the pair of co-phased elements 402 in FIG. 4) is given by the arithmetic mean of the position vectors of the elements in the pair.

With subarraying, the power transmitted from each antenna element 402 is halved, but the overall radiated power is unchanged (when compared with the phased array transmitter 100 in FIG. 1). When compared with the phased array transmitter 100, there are twice the number of antenna elements 402, and the signal from each antenna element 402 has an amplitude equal to the square root of half the amplitude of the signal from an antenna element 102. The amplitudes add coherently, which doubles the peak beam power density.

The following table compares the effect of subarraying to the effect of doubling the size of the array, with respect to the number of delay paths, the number of antenna elements, the total radiated power, and the peak beam power density (Sₘₐₓ, measured in Watts per Steradian).

| | | Number of | | |
|---|---|---|---|---|
| | Number of | antenna | Total radiated | Peak beam |
| Architecture | delay paths | elements | power | power density |
| Small array | N | N | P | Sₘₐₓ |
| (e.g. FIG. 1) | | | | |
| Small array | N | 2N | P | 2Sₘₐₓ |
| with 2:1 | | | | |
| subarraying | | | | |
| (e.g. FIG. 4) | | | | |
| Double size | 2N | 2N | 2P | 4Sₘₐₓ |
| array | | | | |

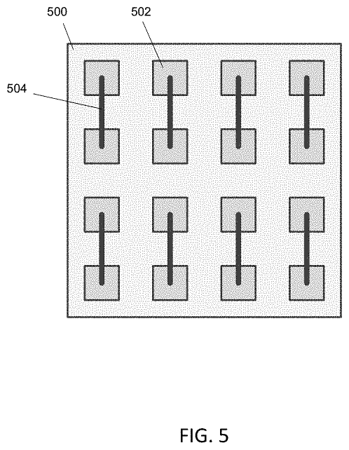

FIG. 5 is a schematic diagram of an antenna array 500 with subarraying. Compared with the antenna array 200 shown in FIG. 2, the antenna array 500 has the same number of independent phase delayed signal paths (eight), but each signal path is routed to a pair of vertically arranged, co-phased elements 502. The lines 504 in FIG. 5 are used to indicate the pairings of the co-phased elements 502 in the antenna array 500 and are not physical components of the antenna array 500.

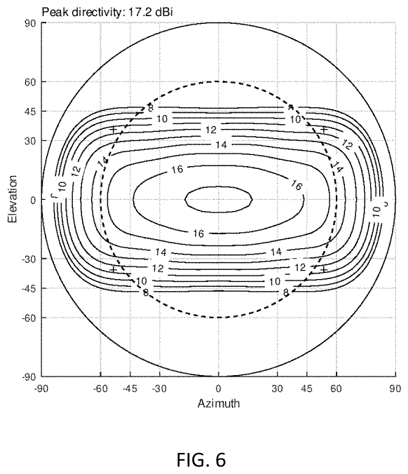

FIG. 6 is a plot of simulated directivity coverage using the antenna array 500 in FIG. 5. As with FIG. 3, FIG. 6 shows the simulated achievable directivity in azimuth and elevation directions, assuming that the beam is steered into the direction indicated by the azimuth and elevation parameters. Again, for the plot shown in FIG. 6, an element spacing of λ/2 is assumed.

With subarraying of the pairs of elements 502 in the antenna array 500, the peak directivity improves by 3 dB to 17.2 dBi (as expected). That is, peak signal power is doubled. FIG. 6 shows that higher directivity is observed. For example, at 60° azimuth direction and 0° elevation, the directivity is in excess of 14.5 dBi. However, the trade-off for the increase in signal power and directivity is a dramatic reduction in scanning capability in the elevation (vertical) direction. This is because the direction in which subarraying is applied leaves fewer independent elements in that direction. In FIG. 5, subarraying is applied in the vertical direction, meaning that the number of independent elements in the vertical direction is halved. The reduction in elements in the direction in which subarraying is applied reduces the ability to create beams at steeper angles from the array normal vector.

The antenna array according to the present disclosure improves antenna directivity in the boresight direction (i.e. the direction in which the antenna is pointing, usually normal to the array plane with azimuth and elevation equal to zero), without overly sacrificing the scan range of the array.

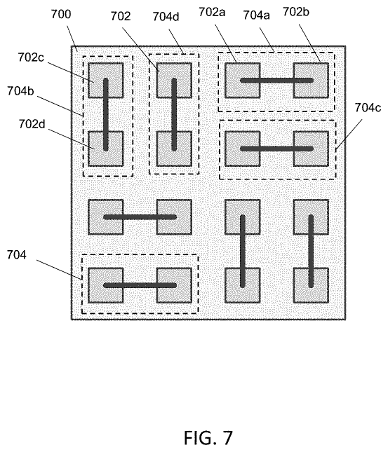

FIG. 7 is a schematic diagram of an antenna element arrangement (shown in FIG. 7 in the form of an antenna array 700) according to the present disclosure. The antenna array 700 forms part of an antenna which can operate either in a transmit mode (in which electromagnetic signals are radiated by the elements of the antenna array 700) and/or in a receive mode (in which electromagnetic signals are received by the elements of the antenna array 700).

As shown in FIG. 7, the antenna array 700 comprises a plurality of groups of elements 702. Specifically, the antenna array 700 comprises eight groups of elements. Each group of elements 702 comprises a plurality of co-phased elements 702. In the antenna array 700, each group is a pair 704 of elements 702 (i.e. each group comprises two elements 702). As with FIG. 5, the black lines between elements in FIG. 7 are used to indicate the pairings of the elements 702 in the antenna array 700 and are not physical components of the antenna array 700.

The antenna array 700 is configured for use with a plurality of phase shifters. For example, the antenna array 700 is fed by an arrangement of amplifiers and phase shifters similar to the arrangement shown in FIG. 4 (which implements subarraying). However, as there are eight groups of elements 702 in the array 700 in FIG. 7, it will be appreciated that the array 700 will be fed by a circuit that includes double the number of phase shifters and amplifiers to the number shown in FIG. 4, in order to provide the eight independent signal paths. This means that each group of elements 702 accepts from one of the phase shifters, in the transmit mode, an electrical signal with a different phase delay. Likewise, in the receive mode, each group of elements 702 supplies to one of the phase shifters, an electrical signal with a different phase delay.

The elements in each group of elements 702 are locked in phase, and can be referred to as “co-phased” elements. This means that the elements 702 in each group of elements accept an electrical signal from the same phase shifter. The signal feed lines between the phase shifters and the antenna elements may be arranged so that the element phases are identical. Alternatively, the signal feed lines between the phase shifters and the antenna elements 702 may have different lengths, so that the antenna element phases are different but still locked in phase (and therefore still considered “co-phased”). In this alternative case, there will be a phase relationship between the antenna elements 702 within each group of elements. The phase relationship will, in this case, depend on the wavelength of the electromagnetic signal transmitted (or received) by the antenna elements 702.

The antenna array 700 comprises a first pair 704a comprising a first plurality of elements 702 (co-phased elements 702a and 702b). Elements 702a and 702b are aligned in a first direction (horizontally in FIG. 7). In the transmit mode, each of elements 702a and 702b accepts an electrical signal from a first phase shifter. In the receive mode, each of elements 702a and 702b supplies an electrical signal to the first phase shifter. The antenna array 700 also comprises a second pair 704b comprising a second plurality of elements 702 (co-phased elements 702c and 702d). Elements 702c and 702d are aligned in a second direction (vertically in FIG. 7). The first and second directions are nonparallel. In the transmit mode, each of elements 702c and 702d accepts an electrical signal from a second phase shifter (i.e. a different phase shifter to the phase shifter that supplies an electrical signal to elements 702a and 702b). In the receive mode of the antenna array 700, each of elements 702c and 702d supplies an electrical signal to the second phase shifter.

In the transmit mode, each of elements 702a and 702b is arranged to transmit an electromagnetic signal with a first phase delay. Each of elements 702c and 702d is arranged to transmit the electromagnetic signal with a second phase delay, which is different to the first phase delay.

Likewise, in the receive mode, each of elements 702a and 702b is arranged to receive an electromagnetic signal with a first phase delay. Each of elements 702c and 702d is arranged to receive the electromagnetic signal with a second phase delay, which is different to the first phase delay.

As noted above, the pairs of elements 702 are aligned in directions that are nonparallel. This means that the pairs 704 of co-phased elements are arranged such that the alignment of the first element 702a of the first pair 704a and the second element 702b of the first pair 704a is angled with respect to the alignment of the first element 702c of the second pair 702b and the second element 702d of the second pair 702b. Specifically, in FIG. 7, elements 702a and 702b of the first pair 704a are aligned in a first direction (horizontally in FIG. 7), which is parallel to the azimuth direction of the antenna, and elements 702c and 702d of the second pair 702b are aligned in a second direction (vertically in FIG. 7), which is parallel to the elevation direction of the antenna. This means that the alignment of elements 702a and 702b is at a 90° angle to the alignment of elements 702c and 702d.

In other words, a first (imaginary) centerline through the first element 702a of first pair 704a and the second element 702b of the first pair 704a is at an angle to a second (imaginary) centerline through the first element 702c of the second pair 704b and the second element 702d of the second pair 704b. Specifically, the centerline through elements 702a and 702b is at 90° to the centerline through elements 702c and 702d.

The angle between the alignment of elements 702a and 702b and the alignment of elements 702c and 702d means that a component of the alignment of elements 702a and 702b is perpendicular to the alignment of elements 702c and 702d. The perpendicular component of the alignment of elements 702a and 702b (with respect to the alignment of elements 702c and 702d) provides increased scan range over the arrangement of the elements 502 of the antenna array 500 in FIG. 5.

Specifically, in FIG. 7, the alignment of elements 702a and 702b is perpendicular the alignment of elements 702c and 702d, meaning that no component of the alignment of elements 702a and 702b is parallel to the alignment of elements 702c and 702d.

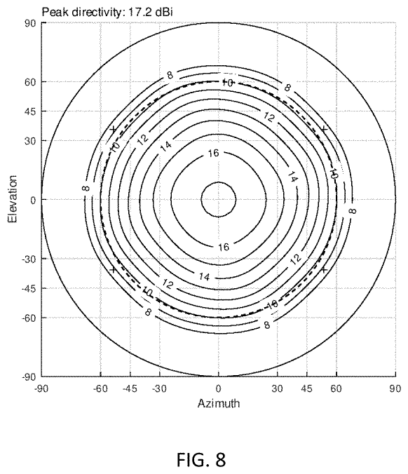

FIG. 8 is a plot of simulated directivity coverage using the antenna array 700 in FIG. 7. Again, FIG. 8 shows the simulated achievable directivity in azimuth and elevation directions, assuming that the beam is steered into the direction indicated by the azimuth and elevation parameters. An element spacing of λ/2 is again assumed.

FIG. 8 shows that the peak directivity is still improved by 3 dB compared to the antenna array without subarraying (i.e. the antenna array shown in FIG. 2). This provides a similar peak directivity improvement to the improvement achieved when using subarraying with co-phased pairs aligned in a consistent direction (i.e. as shown in FIG. 5).

In addition, FIG. 8 shows that the coverage achieved at the 60° circle around the boresight direction is nearly as high (approximately 10 dBi) as with the array shown in FIG. 2. Therefore, the antenna array 700 in FIG. 7 provides increased scan range over the antenna array 500 in FIG. 5. The trade-off for the increase in coverage achieved at the 60° circle (i.e. the increase in scan range in the elevation direction) is a reduction in directivity at lower elevation angles in the azimuth direction. For example, at 60° azimuth direction and 0° elevation, the directivity achieved with the antenna array in FIG. 7 is approximately 10 dBi, compared with approximately 14.5 dBi for the antenna array in FIG. 5.

Returning to the antenna array 700 shown in FIG. 7, it can be seen that a first plurality of the pairs 704 of co-phased elements 702 are oriented in the first direction and a second plurality of the pairs 704 of co-phased elements 702 are oriented in the second direction (which is nonparallel to, or at an angle to, the first direction). Specifically, in FIG. 7, the first direction is perpendicular (i.e. at 90°) to the first direction. In the antenna array 700, four pairs 704 are oriented in the first direction (i.e. horizontally) and four pairs 704 are oriented in the second direction (i.e. vertically). This means that the number of pairs 704 oriented in the first direction is equal to the number of pairs 704 oriented in the second direction. By having equal numbers of pairs 704 oriented in the first and second directions, the coverage pattern is symmetric (i.e. as wide in the vertical (elevation) plane as in the horizontal (azimuth) plane).

In the antenna array 700, each pair 704 of elements 702 is adjacent to a pair 704 of elements 702 oriented in the same direction as it. For example, each element 702a, 702b of the first pair 704a is adjacent to an element of a third pair 704c. Likewise, each element 702c, 702d of the second pair 704b is adjacent to an element of a fourth pair 704d. This arrangement of antenna elements 702 in the antenna array 700 of FIG. 7 can be described as a “basket” pattern.

In the basket pattern, the antenna array 700 includes sixteen antenna elements 702 arranged in a four-by-four array. The antenna array 700 can be divided into four quadrants. The two pairs 704 of co-phased elements 702 in the top-left and bottom-right quadrants are oriented in a vertical direction. The two pairs 704 of co-phased elements 702 in the top-right and bottom-left quadrants are oriented in a horizontal direction.

Variations or modifications to the antenna element arrangement shown in FIG. 7 are set out in the following paragraphs.

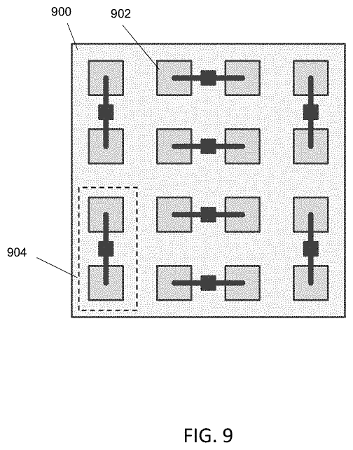

FIG. 9 shows an alternative arrangement for an antenna array 900, in which antenna array elements are arranged in a “ladder” pattern. In the ladder pattern, the antenna array 900 again includes sixteen antenna elements 902, arranged in a four-by-four array. The elements 902 are divided into eight co-phased pairs 904. The pairs 904 spanning a centerline (e.g. a vertical centerline) through the antenna array 900 are oriented perpendicular to the centerline. The remaining pairs 904 (located furthest from the centerline) are oriented parallel to the centerline. In the antenna array 900, the pairs 904 spanning the vertical centerline through the antenna array 900 are oriented horizontally and the remaining pairs are oriented vertically.

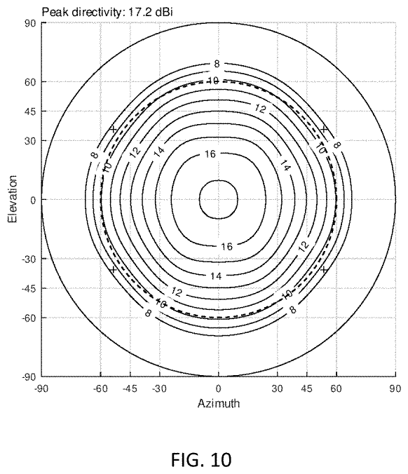

The small black squares in FIG. 9 show the locations for which the element phases have been calculated (for the plot shown in FIG. 10). In each case, the phase assigned to paired elements is assumed to be the phase associated with the midpoint between the elements.

FIG. 10 is a plot of simulated directivity using the antenna array 900 in FIG. 9. Again, FIG. 10 shows the simulated achievable directivity in azimuth and elevation directions, assuming that the beam is steered into the direction indicated by the azimuth and elevation parameters. An element spacing of λ/2 is again assumed.

It can be seen from FIG. 10 that the directivity and scan range performance of the ladder pattern is very similar to the directivity and scan range performance of the basket pattern. That is, a peak directivity of 17.2 dBi and directivity of approximately 10 dBi at the 60° circle around the boresight direction. This means that the performance is almost independent of the antenna array pattern used. This offers additional flexibility because either pattern can be used depending on which is most conveniently integrated with a feed network that feeds the signal to be transmitted to the antenna and/or carries the electrical signal produced by reception of the signal at the antenna.

The antenna elements may be fed by a beamformer chip that contains the amplifiers and phase shifters (e.g. as shown in FIGS. 1 and 4). Transmission line tracks on a printed circuit board (PCB) are used to convey the signal from the beamformer chip to the midpoint between the co-phased elements. Depending on the beamformer configuration and the number of groups of elements, one pattern may provide for simpler layout of the transmission tracks on the PCB. For example, if four pairs of elements are used with a four channel beamformer, then the ladder arrangement is preferable because the beamformer can sit in the middle of the groups of elements (i.e. substantially equidistant from the midpoints of the element pairs).

In addition, it is preferable for the transmission line tracks to have the same length, because the signal phase radiated by the antenna elements depends on the track length (φ=2π×length/wavelength). If the track lengths are different, then the phase radiated by the elements will change in an undesirable manner with frequency, as a result of the changes in wavelength. Unequal track lengths therefore cause a reduction in bandwidth for the antenna system. Simplifying the layout of the co-phased elements may allow equal track lengths to be used or the track length differences to be minimised.

Given that performance is almost independent of the antenna array pattern, other 4×4 antenna element arrangements will give similar performance to the antenna arrays of FIGS. 7 and 9, as long as the same number of co-phased element pairs are arranged in each direction.

Although the antenna arrays in FIGS. 7 and 9 include the same number of co-phased pairs oriented in each direction, improved directivity and scan range performance can be achieved with unequal numbers of co-phased pairs oriented in each direction. For example, more pairs of co-phased elements may be oriented in the vertical direction than in the horizontal direction. In this case, the coverage pattern will be narrower in the vertical (elevation) plane and more elongate in the horizontal (azimuth) plane than the plots shown in FIGS. 8 and 10. In other words, the shape of the coverage pattern will be in between the plot shown in FIG. 6 and the plots shown in FIGS. 8 and 10.

In fact, rotating a single pair or group of co-phased elements out of alignment with the other pairs or groups of co-phased elements in the antenna element arrangement (i.e. so that the alignment of the rotated pair or group is nonparallel to the alignment of the other pairs or groups) will provide some improvement in scan range over the antenna array shown in FIG. 5.

Although all elements in the antenna arrays in FIGS. 7 and 9 are paired, improved directivity and scan range performance can be achieved with an antenna element arrangement in which only some of the elements are paired (i.e. in which some individual elements are fed by corresponding phase shifters, and some paired elements are fed by other phase shifters).

Although the antenna arrays in FIGS. 7 and 9 include 16 elements, the basket and ladder patterns may be extended to arrays with different numbers of elements. Improved directivity and scan range performance can be achieved with an antenna element arrangement with any other number of elements (provided that the number of elements is greater than four, which is the most basic case where two pairs of elements are aligned in nonparallel directions). For example, arrays with 8, 16, 24, 32, 48 or 64 elements may be used. Arrays of these sizes allow the elements to be divided into pairs of elements that are fed by the same phase shifter.

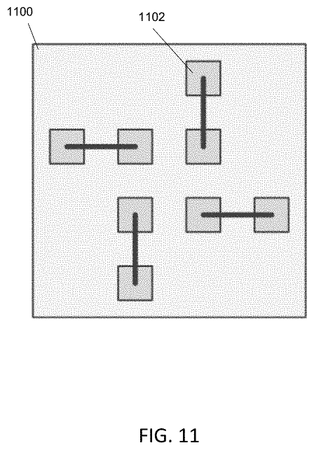

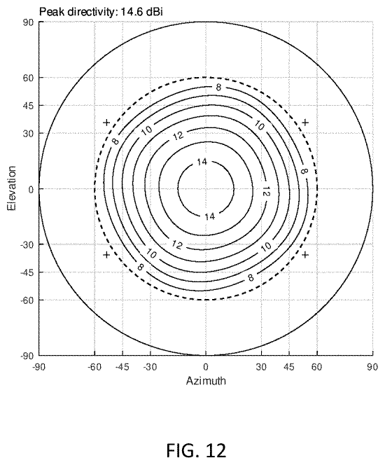

Although the antenna arrays in FIGS. 7 and 9 include the same number of elements in the first and second directions (i.e. they are 4×4 arrays), improved directivity and scan range performance can be achieved with unequal numbers of elements in the first and second directions (e.g. a 2×4 array or a 6×4 array). In addition, the elements do not need to be arranged in an array. Example alternative antenna element arrangements are shown in FIGS. 11 and 12.

FIG. 11 shows an alternative antenna element arrangement 1100 where the co-phased elements 1102 are not arranged in a compact rectangular grid. Instead, four elements 1102 are arranged in a 2×2 pattern in the centre of the antenna. A fifth element is horizontally adjacent to the top-left element of the 2×2 pattern. A sixth element is vertically adjacent to the top-right element of the 2×2 pattern. A seventh element is horizontally adjacent to the bottom-right element of the 2×2 pattern. An eighth element is vertically adjacent to the bottom-left element of the 2×2 pattern. This arrangement provides increased directivity (over the arrangement in FIG. 2), as shown in the simulated directivity coverage plot in FIG. 12.

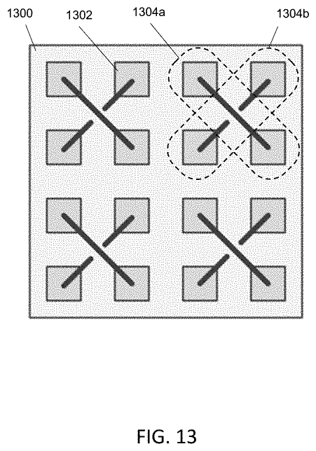

Although the antenna arrays in FIGS. 7 and 9 include the co-phased pairs of elements in horizontal and vertical directions, improved directivity and scan range performance can be achieved with co-phased pairs of elements arranged at other angles. FIG. 13 shows an alternative antenna element arrangement 1300 where the elements 1302 are arranged in a 4×4 array which can be divided into four quadrants. In each quadrant, the top-left and bottom-right elements 1302 belong to a first co-phased pair 1304a, and the top-right and bottom-left elements 1302 belong to a second co-phased pair 1304b, thereby forming an ‘X’-shape. The crossed lines in FIG. 13 show that two pairs of elements 1302 are co-phased, not that all four elements are co-phased.

Although the antenna arrays in FIGS. 7 and 9 are two-dimensional, improved directivity and scan range performance can be achieved with co-phased pairs of elements in three-dimensional antenna element arrangements, provided that groups of co-phased elements are aligned in nonparallel directions.

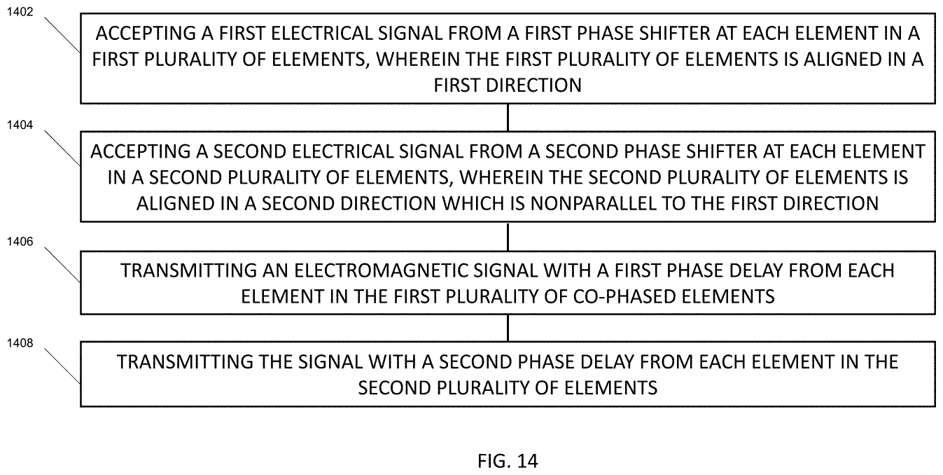

FIG. 14 is a flowchart of a method of transmitting an electromagnetic signal using an antenna element arrangement with groups of antenna elements aligned in different directions.

A signal to be transmitted is fed to a number of amplifiers corresponding to the number of groups of co-phased elements. The output from each amplifier is fed to a corresponding phase shifter. Each phase shifter shifts applies a phase delay to the output from its corresponding amplifier. A first phase shifter may apply a phase delay of zero to the output from a first amplifier. The phase delayed output from the phase shifter is then split into a number of branches corresponding to the number of co-phased elements in each group of co-phased elements.

Then, at 1402, a first electrical signal from the first phase shifter is accepted at each element in a first plurality of elements. The first plurality of elements is aligned in a first direction.

At 1404, a second electrical signal from a second phase shifter is then accepted at each element in a second plurality of elements. The second plurality of elements is aligned in a second direction, which is nonparallel to the first direction.

Then, at 1406, an electromagnetic signal is transmitted with a first phase delay from each element in the first plurality of elements. The first phase delay may be zero.

At 1408, the electromagnetic signal is transmitted with a second phase delay from each element in the second plurality of elements.

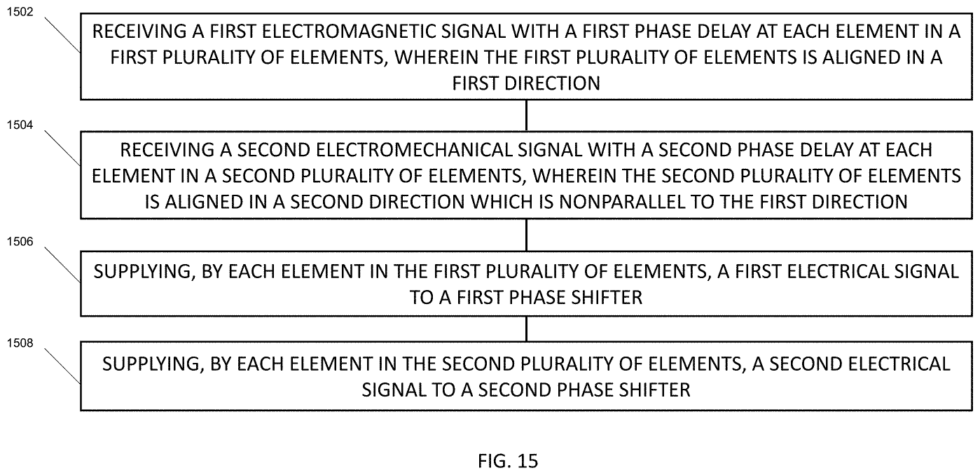

FIG. 15 is a flowchart of a method of receiving an electromagnetic signal using an antenna element arrangement with groups of antenna elements aligned in different directions.

At 1502, the electromagnetic signal is received with a first phase delay at each element in a first plurality of elements. The first plurality of elements is aligned in a first direction. The first phase delay may be zero.

At 1504, the electromagnetic signal is received with a second phase delay at each element in a second plurality of elements. The second plurality of elements is aligned in a second direction, which is nonparallel to the first direction.

Then, at 1506, a first electrical signal is supplied to a first phase shifter by each element in the first plurality of elements. The signals supplied by each element in the first plurality of elements may be summed and fed to the first phase shifter, which applies a phase delay to the summed signal.

At 1508, a second electrical signal is supplied to a second phase shifter by each element in the second plurality of elements. The signals supplied by each element in the second plurality of elements may be summed and fed to the second phase shifter, which applies a phase delay to the summed signal. The phase delayed signals output from the phase shifters are then summed.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. An antenna element arrangement configured for use with a plurality of phase shifters, the antenna element arrangement comprising:
a first group of elements comprising a first plurality of elements aligned in a first direction, each element in the first plurality of elements arranged to accept, in a transmit mode, a first electrical signal from a first phase shifter or to supply, in a receive mode, a first electrical signal to the first phase shifter; and
a second group of elements comprising a second plurality of elements aligned in a second direction, each element in the second plurality of elements arranged to accept, in the transmit mode, a second electrical signal from a second phase shifter or to supply, in the receive mode, a second electrical signal to the second phase shifter;
wherein the first and second directions are nonparallel.

2. An antenna element arrangement according to claim 1, wherein the first direction is perpendicular to the second direction.

3. An antenna element arrangement according to claim 1, wherein in the transmit mode, each element in the first plurality of elements is arranged to transmit an electromagnetic signal with a first phase delay and each element in the second plurality of elements is arranged to transmit the electromagnetic signal with a second phase delay, wherein the second phase delay is different to the first phase delay.

4. An antenna element arrangement according to claim 1, wherein in the receive mode, each element in the first plurality of elements is arranged to receive an electromagnetic signal with a first phase delay and each element in the second plurality of elements is arranged to receive the electromagnetic signal with a second phase delay, wherein the second phase delay is different to the first phase delay.

5. An antenna element arrangement according to claim 1, wherein the first electrical signal has a first phase delay and the second electrical signal has a second phase delay different to the first phase delay.

6. An antenna element arrangement according to claim 1, wherein each of the first and second groups of elements is a pair of elements.

7. An antenna element arrangement according to claim 1, comprising a first plurality of groups of elements aligned in the first direction.

8. An antenna element arrangement according to claim 7, comprising a second plurality of groups of elements aligned in the second direction.

9. An antenna element arrangement according to claim 8, wherein the number of groups of elements in the first plurality of groups of elements is equal to the number of groups of elements in the second plurality of groups of elements.

10. An antenna element arrangement according to claim 7, wherein the first plurality of groups of elements comprises the first group of elements and a third group of elements, wherein each element in the first group of elements is adjacent to an element of the third group of elements.

11. An antenna element arrangement according to claim 10, wherein the second plurality of groups of elements comprises the second group of elements and a fourth group of elements, wherein each element in the second group of elements is adjacent to an element of the fourth group of elements.

12. An antenna element arrangement according to claim 1, wherein the elements are arranged in an array.

13. An antenna element arrangement according to claim 12, wherein the array is a two-dimensional array.

14. An antenna element arrangement according to claim 1, wherein the first direction is parallel to an elevation direction of an antenna.

15. An antenna element arrangement according to claim 1, wherein the second direction is parallel to an azimuth direction of an antenna.

16. An antenna element arrangement according to claim 1, further comprising a plurality of individual elements, wherein each individual element is arranged to transmit, in the transmit mode, an electromagnetic signal with a different phase delay to the electromagnetic signals transmitted by the groups of elements.

17. An antenna comprising an antenna element arrangement according to claim 1.

18. A method of transmitting an electromagnetic signal using an antenna comprising an antenna element arrangement, the method comprising:
accepting, at each element in a first plurality of elements of the antenna element arrangement, a first electrical signal from a first phase shifter, wherein the first plurality of elements is aligned in a first direction;
accepting, at each element in a second plurality of elements of the antenna element arrangement, a second electrical signal from a second phase shifter, wherein the second plurality of elements is aligned in a second direction, wherein the first and second directions are nonparallel;
transmitting an electromagnetic signal with a first phase delay from each element of the first plurality of elements; and
transmitting the electromagnetic signal with a second phase delay from each element of the second plurality of elements.

19. A method of receiving an electromagnetic signal using an antenna comprising an antenna element arrangement, comprising:
receiving an electromagnetic signal with a first phase delay at each element in a first plurality of elements of the antenna element arrangement, wherein the first plurality of elements is aligned in a first direction; and
receiving the electromagnetic signal with a second phase delay at each element in a second plurality of elements of the antenna element arrangement, wherein the second plurality of elements is aligned in a second direction, wherein the first and second directions are nonparallel;
supplying, by each element in the first plurality of elements, a first electrical signal to a first phase shifter; and
supplying, by each element in the second plurality of elements, a second electrical signal to a second phase shifter.
